(19) United States
(12) Patent Application Publication
(10) Pub. No.: US 2013/0231427 A1
(43) Pub. Date: Sep. 5, 2013

(54) METHOD OF FORMING AN OBJECT USING POWDER INJECTION MOLDING

(71) Applicants: Su Xia Zhang, Singapore (SG); Tao Li, Singapore (SG); Zi Yan Ong, Singapore (SG); Yonghui Bai, Singapore (SG)

(72) Inventors: Su Xia Zhang, Singapore (SG); Tao Li, Singapore (SG); Zi Yan Ong, Singapore (SG); Yonghui Bai, Singapore (SG)

(21) Appl. No.: 13/884,261

(22) PCT Filed: Nov. 4, 2011
(86) PCT No.: PCT/SG2011/000393

§ 371 Date: May 8, 2013

Related U.S. Application Data
(60) Provisional application No. 61/411,317, filed on Nov. 8, 2010.

(51) Int. Cl. B22F 3/12; C04B 35/64; B29C 45/00

(52) U.S. Cl. CPC B22F 3/12; B29C 45/0001; C04B 35/64
USPC 524/277; 264/645; 419/38; 419/39

(57) ABSTRACT

A method of forming an object by powder injection molding, the object being formed from an injection molded integral body comprising a green part contiguous with an expendable part, the method comprising debinding the integral body at step 18 to obtain a debound green part contiguous with a debound expendable part; sintering the debound green part at step 20 at a sintering temperature, the debound expendable part configured to at least partially define the debound green part and has a melting point higher than the sintering temperature; and separating the debound expendable part from the sintered debound green part at step 22 to form the object.

### FIELD OF THE INVENTION

The invention relates to a method of forming an object using powder injection molding and particularly, though not exclusively, to forming relatively large objects.

### BACKGROUND

Powder injection molding was developed as a process to combine the advantages of plastic injection molding together with the desired properties of a chosen material. The advantages include being able to form complex shapes quickly at relatively low cost. When forming an object using powder injection molding, feedstock prepared from a mixture of a chosen material and a binder is first injection molded to form a green part. This is followed by debinding or removal of the binder from the green part to form a debound green part. The debound green part is finally sintered to form a sintered part.

However, conventional processes using powder injection molding face drawbacks such as shape distortion after debinding, fragility of the debound green part, and lack of tight tolerances of the sintered part. Such problems are exacerbated when attempting to form objects having complex internal cavities and/or relatively large objects. In addition, secondary processes such as coining, machining and/or deburring become necessary in order to arrive at the desired final object from the sintered part when the sintered part suffers from shape distortion and/or poor dimensional tolerances, which thus increasing costs and production time.

### SUMMARY

According to a first exemplary aspect, there is provided a method of forming an object by powder injection molding, the object being formed from an injection molded integral body comprising a green part contiguous with an expendable part, the method comprising debinding the integral body to obtain a debound green part contiguous with a debound expendable part, sintering the debound green part at a sintering temperature, the debound expendable part configured to at least partially define the debound green part and has a higher melting point than the sintering temperature; and separating the debound expendable part from the sintered debound green part to form the object.

By providing the expendable part to support the green part both after debinding and during sintering, structural integrity of the debound green part may be maintained, allowing the object formed to have larger sizes and to have tighter tolerances on its dimensions and shape.

During sintering of the debound green part, the debound expendable part may remain substantially unsintered and/or chemically unreacted with the debound green part.

Sintering the debound green part may comprise subjecting the debound integral body to the sintering temperature that is lower than the melting point of the debound green part, and lower than a temperature above which the debound green part and/or the debound expendable part ceases to sustain its pre-sintering shape.

The method may further comprise injection molding a first feedstock in a mold cavity to form the green part contiguous with the expendable part, thereby forming the integral body, the mold cavity being defined by a first mold and the expendable part placed in the first mold prior to injection molding of the first feedstock.

Injection molding the first feedstock may be performed at a temperature ranging from about 40° C. to about 100° C. at the first mold, and about 100° C. to about 200° C. at an injection nozzle. Alternatively, the injection molding temperature may be between about 40° C. and about 65° C., between about 60° C. and about 80° C., or about 70° C. at the first mold, and may be between about 100° C. and about 160° C., between about 150° C. and about 180° C., between about 160° C. and about 170° C. or at about 165° C. at the injection nozzle. Injection molding the first feedstock may be performed at a temperature selected to be higher than a temperature above which a purely polymeric expendable part ceases to sustain its desired shape.

Injection molding the first feedstock may be performed at an injection pressure ranging from about 50 bar to about 3000 bar when flowing the first feedstock into the mold cavity, and a holding pressure ranging from 200 bar to 1000 bar when the mold cavity is substantially filled. In the alternative, the injection pressure may be about 100 bar to about 2500 bar, about 200 bar to about 2000 bar, about 300 bar to about 1500 bar or about 500 bar to about 1000 bar, and the holding pressure may be about 300 bar to about 900 bar, about 400 bar to about 800 bar or about 500 bar to about 700 bar. Injection molding the first feedstock may be performed at an injection pressure selected to be higher than a pressure above which a conventional purely polymeric expendable part ceases to sustain its desired shape.

The method may further comprise preparing the first feedstock by mixing a first material in powder form with a first binder at a temperature ranging from about 130° C. to about 200° C. The temperature may preferably be about 140° C. to about 190° C., about 150° C. to about 180° C., or about 160° C. to about 170° C.

The method may further comprise injection molding a second feedstock in a second mold to form the expendable part.

Injection molding the second feedstock may be performed at a temperature ranging from about 40° C. to about 100° C. at the second mold, and about 130° C. to about 200° C. at an injection nozzle. The temperature at the second mold may be between about 50° C. and about 90° C., between about 60° C. and about 80° C., or at about 70° C. and at the injection nozzle may be between about 140° C. and about 190° C., between about 150° C. and about 180° C., between about 160° C. and about 170° C., or at about 165° C.

Injection molding the second feedstock may be performed at an injection pressure ranging from 50 bar to 3000 bar when flowing the second feedstock into the second mold, and a holding pressure ranging from 200 bar to 1000 bar when the second mold is substantially filled. In the alternative, the injection pressure may be about 100 bar to about 2500 bar, about 200 bar to about 2000 bar, about 300 bar to about 1500 bar or about 500 bar to about 1000 bar, and the holding pressure may be about 300 bar to about 900 bar, about 400 bar to about 800 bar or about 500 bar to about 700 bar.

The method may further comprise preparing the second feedstock by mixing a second material in powder form with a second binder at a temperature ranging from 130° C. to 200° C. Preferably, the temperature may be between about 140° C. and about 190° C., between about 150° C. and about 180° C., between about 160° C. and about 170° C.

The first binder may be compositionally the same as the second binder.

The second material may constitute a selectable volume ranging from about 10% to about 80% of the second feedstock. Preferably, the volume range may be about 20% to about 45%, about 30% to about 60%, or about 40% to about 50% of the second feedstock.

The second material may be selected such that after sintering the debound green part, the second material remains essentially in powder form.

The second material may be selected to have a coefficient of thermal expansion smaller than or similar to a coefficient of thermal expansion of the debound green part.

Debinding the integral body may comprise dissolving in at least one solvent at least one component of a first binder in the green part and at least one component of a second binder in the expendable part. Preferably, the first binder and the second binder are compositionally the same.

The dissolving may be performed at a temperature ranging from about 30° C. to about 80° C. for a time ranging from 8 to 24 hours. The dissolving may also be performed at a temperature of between about 40° C. and about 70° C., between about 50° C. and about 60° C. or at about 65° C. and a corresponding variation of the time.

Debinding the integral body may comprise thermal debinding a first binder in the green part and a second binder in the expendable part from the green part and the expendable part respectively.

The thermal debinding may be performed by increasing the temperature of the integral body at a rate ranging from about 0.1° C. to about 1° C. per minute until a thermal debinding temperature ranging from about 500° C. to about 800° C. is attained, and maintaining the thermal debinding temperature for a time ranging from 2 to 6 hours. The rate of increase of the temperature may be from about 0.2° C. to about 0.9° C. per minute, from about 0.3° C. to about 0.8° C. per minute, from about 0.4° C. to about 0.7° C. per minute or about 0.5° C. to about 0.6° C. per minute, until the corresponding thermal debinding temperature range is reached. The thermal debinding temperature to be reached may be from about 550° C. to about 750° C., or from about 600° C. to about 700° C.

Separating may comprise mechanically removing the debound expendable part from the sintered debound green part.

According to a second exemplary aspect, there is provided a method of forming an object by powder injection molding, the method comprising placing an expendable body in a first mold to define a mold cavity, injection molding a first feedstock in the mold cavity to form an integral body comprising a green part contiguous with the expendable body, ejecting the integral body from the first mold, debinding the integral body to obtain a debound green part contiguous with a debound expendable part, sintering the debound green part at a sintering temperature, the debound expendable part configured to at least partially define the debound green part and has a melting point higher than the sintering temperature, and separating the debound expendable part from the sintered debound green part to form the object.

According to a third exemplary aspect, there is provided a powder injection molded object formed by any of the aspects described above.

It should be appreciated that features relating to one aspect may also be applicable to the other aspects.

### BRIEF DESCRIPTION OF THE DRAWINGS

In order that the invention may be fully understood and readily put into practical effect there shall now be described by way of non-limitative example only exemplary embodiments of the present invention, the description being with reference to the accompanying illustrative drawings.

In the drawings:

FIG. 1 is a flow chart of an exemplary method of forming an object using powder injection molding;

FIG. 2 is a schematic diagram of an expendable part;

FIG. 3 is a schematic diagram of a green part contiguous with the expendable part of FIG. 2; and

FIG. 4 is a schematic diagram of the object formed using the method in the flow chart of FIG. 1.

### DETAILED DESCRIPTION OF THE EXEMPLARY EMBODIMENTS

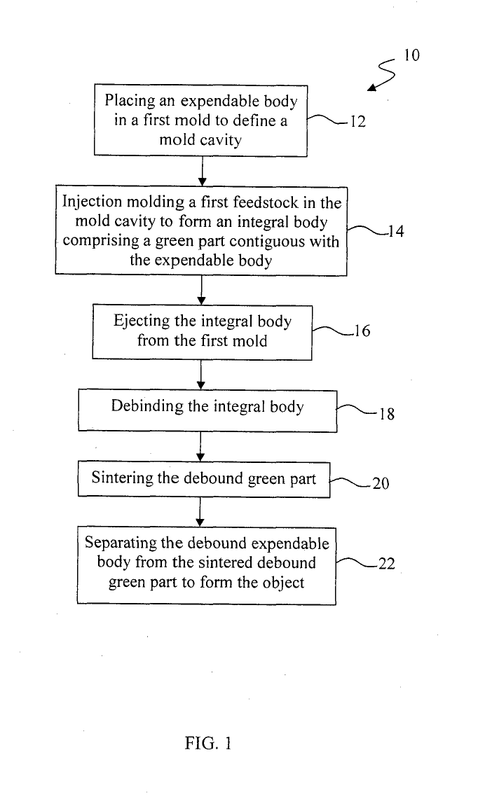

An exemplary method 10 of forming an object using powder injection molding will be described below with reference to FIGS. 1 to 4.

In one embodiment, the method 10 includes injection molding a first feedstock in a mold cavity 14, the mold cavity being defined by a first mold and at least one expendable body or part 100 placed in the first mold 12. The at least one expendable part 100 is placed in the first mold 12 prior to injection molding of the first feedstock 14 in order to define features of the object 400 to be formed. The expendable part 100 is described as expendable since it is intended to be used and then destroyed, although the material left after destruction may advantageously be reused or recycled. The expendable part 100 therefore can be considered a sacrificial part 100. The method 10 thus comprises powder injection over-molding of the first feedstock over the sacrificial part 100.

The first feedstock comprises a first material in powder form mixed with a first binder. The term “powder” is used here to refer to one or more types of materials in a particulate or granular form, not being limited in the shape or size of the particles or granules. The first material may be an elemental, alloyed, or compound material, and includes ceramic, metallic, non-metallic, semi-metallic materials. The first binder can include a thermoplastic or thermosetting polymer and waxes, with or without additives such as antioxidants, dispersants, plasticizers or compatibilizers, and/or lubricants. An exemplary first binder is a mixture of polypropylene, carnauba wax, and paraffin wax, with stearic acid as an additive.

Preparation of the first feedstock can be done in an inert environment such as in nitrogen, although this is not a necessity. Advantageously, the first feedstock need not be prepared in an inert environment, thus rendering the method cheaper and easier to use. The first feedstock is preferably prepared at a temperature ranging from about 130° C. to about 200° C., although higher or lower temperatures can also be used. Optionally, the first feedstock can also be formed into pellets prior to injection molding.

Exemplary molding temperatures of the first feedstock can be in a range of approximately 130° C. to approximately 200° C. at the injection nozzle, and in a range of approximately 40° C. to approximately 100° C. at the first mold. The first feedstock flows to fill the mold cavity at an injection pressure of approximately 50 bar to approximately 3000 bar, which allows the first feedstock to flow in the mold cavity at a desired rate.

When the mold cavity has been substantially filled with the required amount of first feedstock, a holding pressure of about 200 bar to about 1000 bar is preferably applied to facilitate filling of the mold cavity by the first feedstock in order to form a green part 200. The green part 200 comprises the first material held together by the first binder. Process parameters for powder injection over-molding of the first feedstock, such as the holding time, holding pressure, dimensions of the first mold, etc., can be appropriately varied such that the resulting green part 200 meets the desired requirements of shape and dimensions. After powder injection molding of the first feedstock is complete, an integral body 300 comprising the green part 200 contiguous with the expendable part 100 is formed, as shown in FIG. 3.

The at least one expendable part 100 is preferably also formed using injection molding. To do so, a second material and a second binder are mixed to form a second feedstock that is injection molded into a second mold. The second material is also provided in powder form. The second binder is preferably the same as the first binder. Alternatively, the second binder may have a different composition from the first binder. The second material should have a higher melting temperature than the first material.

The second material can selectably constitute about 10% to 80% by volume of the second feedstock. This enables greater control over the viscosity of the second feedstock during injection molding and hence enables the second feedstock to better fill the second mold during molding of the expendable part 100.

Preparation of the second feedstock can be done in an inert environment or in air. The second feedstock is preferably prepared at a temperature ranging from about 130° C. to about 200° C., although higher or lower temperatures can also be used. The second material may be an elemental, alloyed, or compound material, and includes ceramic, metallic, non-metallic, semi-metallic materials. Optionally, the second feedstock can be formed into pellets prior to injection molding. This advantageously improves repeatability and quality control as well as facilitating materials handling and storage.

To form the expendable part 100, the second feedstock is delivered into the second mold via an injection nozzle. Exemplary molding temperatures can be in a range of approximately 130° C. to approximately 200° C. at the injection nozzle, and in a range of approximately 40° C. to approximately 100° C. at the second mold. The second feedstock flows to fill the second mold at an injection pressure of approximately 50 bar to approximately 3000 bar, which allows the second feedstock to flow in the second mold at a desired rate.

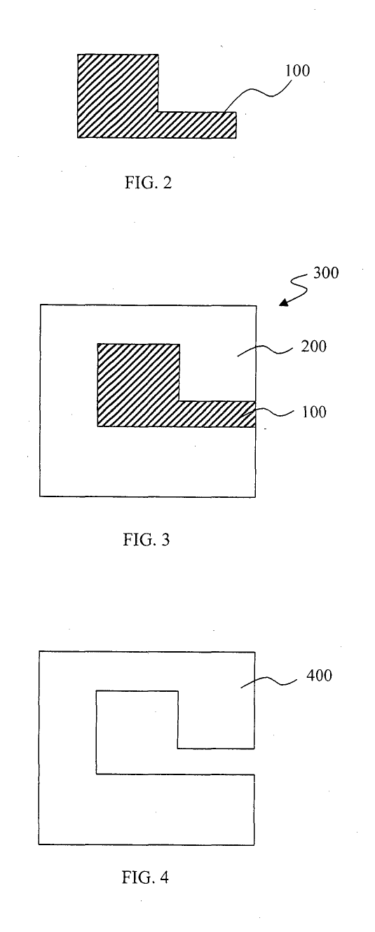

When the second mold has been substantially filled with the required amount of second feedstock, a holding pressure of about 200 bar to about 1000 bar is preferably applied to facilitate filling of the second mold by the second feedstock. A cooling period is preferably provided for the formed expendable part 100 to be cooled down after ejection of the expendable part 100 from the second mold. Alternatively, the expendable part 100 may be allowed to cool in the second mold before ejection. Process parameters for injection molding of the expendable part 100, such as the holding time, holding pressure, dimensions of the second mold, etc., can be appropriately varied such that the resulting expendable part 100 as shown in FIG. 2 meets the desired requirements of shape and dimensions. The expendable part 100 comprises the second material held together by the second binder.

After the integral body 300 has been formed in the first mold through injection molding of the first feedstock, the integral body 300 is removed or ejected from the first mold 16 and subjected to debinding 18. Debinding is to remove the first binder and the second binder from both the green part 200 and the expendable part 100. Debinding may be by a selection of various approaches, for example, by thermal debinding alone, or solvent debinding followed by thermal debinding, etc.

It has been noted that configuring the expendable part 100 to comprise the second material and the second binder as described above allows debinding time of the expendable part 100 and the green part 200 to be more closely matched, making production more efficient. This is clearly an improvement over conventional powder injection molding where the expendable part comprises only polymeric materials that requires the use of catalytic debinding. When the expendable part is of substantial size compared to the green part, catalytic debinding to remove the expendable part can take significantly longer to perform compared to debinding of the green part, for example, using catalytic debinding may take as long as 4 hours to debind the expendable part compared to 1 hour to debind the green part. Such unmatched catalytic debinding can cause cracks in the debound green part.

In solvent debinding, one or more solvents is provided to dissolve components of the first and second binders residing in the green part 200 and in the expendable part 100 respectively. Debinding by dissolving one or more components of the binders can be performed at a solvent debinding temperature of about 30° C. to about 80° C. for about 8 to 24 hours. It will be appreciated that the solvent selection depends on the components of the binder. Suitable solvents may include tichloroethylene (TCE), isopropanol (IPA), acetone or heptane.

In thermal debinding, components in the binders are converted into a gaseous state and thereby escape from the green part 200 and the expendable part 100. The integral body 300 can be heated at a slow rate of temperature increase of about 0.1 to about 1° C. per minute until a thermal debinding temperature of about 500° C. to about 800° C. is attained. The thermal debinding temperature may then be maintained for a holding time ranging from about 2 to 6 hours, for example, or until it is ascertained that substantially all of the binders have evaporated.

Preferably, the first binder and the second binder have the same composition so that the same one debinding process can advantageously disintegrate the binder in the green part 200 and the expendable part 100 respectively. This enables the entire process to be completed in fewer steps and with a smaller bill of materials, which indirectly leads to increased cost efficiency.

What is left after debinding is a debound integral body 300 comprising the debound green part 200 contiguous with the debound expendable part 100. The debound green part 200 and the debound expendable part 100 thus comprise only the first material and the second material respectively, both still in powder form. As the green part 200 was molded at least partially around the expendable part 100, after debinding, the debound expendable part 100 remains contiguous with the debound green part 200. The debound expendable part 100 thus continues to support or help define the debound green part 200 that is now devoid of binder and therefore fragile on its own. The debound expendable part 100 thus helps to retain the structural integrity of the debound green part 200. By providing the debound expendable part 100 as a contiguous support for the debound green part 200, tighter tolerances and minimal shape distortions in the object 400 are thus achievable after sintering of the debound green part 200, 20. On the contrary, expendable parts that are purely polymeric are unable to provide any such support for the debound green part since they are no longer present after debinding and during sintering.

After debinding, the debound green part 200 is sintered at a sintering temperature. This may be achieved by subjecting the debound integral body 300 to the sintering temperature. By configuring the debound expendable part 100 to have a melting point that is higher than the sintering temperature, the debound green part 200 can be sintered to a desired density 20, while leaving the debound expendable part 100 in a substantially unsintered state. The sintering temperature is selected to be slightly below the melting point of the debound green part 200, and lower than a temperature above which the debound green part 200 and/or the debound expendable part 100 will cease to sustain the desired shape. If the sintering temperature is too high, the particles will melt and the parts 100, 200 will not retain their desired shapes. The selection of the sintering temperature is therefore highly dependent on the materials chosen.

In a preferred embodiment, the second powder or material is selected so that the debound expendable part 100 is essentially chemically unreacted under the sintering conditions selected to sinter the debound green part 200. The sintering conditions applied may involve increasing the temperature at a rate of about 1 to 10° C. per minute to the sintering temperature of less than or around 90% of the melting point of the debound green part 200, followed by holding the sintering temperature for about 2 to 6 hours.

After sintering, because the debound expendable part 100 remains substantially unsintered, it is readily separated or removed from the sintered debound green part 200, thereby forming the object 400, 22. Separation can comprise mechanical removal that may be performed simply by shaking, vibrating, applying low pressure air, or any other process suitable forremoving the loose second powder material forming the debound expendable part 100 from the sintered debound green part 200.

A high material-to-binder ratio in the second feedstock used to form the expendable part 100 is likely to complicate eventual removal of the debound expendable part 100 from the sintered debound green part 200. On the other hand, too low a material-to-binder ratio would not provide the expendable part 100 with the required strength needed to support the debound green part 200 for sintering. Embodiments of the present method the second material to the second binder, such that ratios as low as about 10% and as high as about 80% of the second material can be selected. Indirectly, this leads to improved tolerances of the object 400 since the shape of the object 400 is at least partially defined by the expendable part 100.

Furthermore, the greater degree of freedom in selecting the ratio of the second material to the second binder which lends greater control over the viscosity of the second feedstock also enables the use of lower pressure for delivering the second feedstock into the second mold when forming the expendable part 100. This advantageously reduces the likelihood of the second binder vaporizing in the course of molding, and also reduces the likelihood of the expendable part 100 cracking. It is also believed that where the expendable part is purely polymeric without the second material, the expendable part may be unable to adequately withstand high pressure and high temperature conditions of powder injection over-molding by the first feedstock to form the green part, resulting in some degree of deformation in the expendable part during injection molding of the green part, leading to shape distortion of the green part formed. Therefore, by providing the expendable part 100 comprising the second material with the second binder, excellent shape retention is achieved even under high pressure and high temperature injection molding of the first feedstock, leading to excellent dimensional tolerances in the green part 200 and ultimately the object 400 formed.

Advantageously, because the debound expendable part 100 is not extracted from the debound green part 200 prior to sintering, it can continue to provide support to or at least partially define features of the debound green part 200. At the same time, the second material is preferally selected such that after sintering the debound green part, the second material remains essentially in powder form. In this way, the debound expendable part 100 remains in the form of a powder or small particles conducive for easy separation from the sintered debound green part 200 after sintering.

Additionally, by selecting the second material to have a coefficient of thermal expansion that is less than or equal to a coefficient of thermal expansion of the debound green part 200, and because the debound expendable part 100 is not melted in the course of sintering, the debound expendable part 100 does not excessively expand in volume to adversely impact the shape and dimensions of the object 400 during sintering of the debound green part 200. Ideally, the second material and the first material have a similar coefficient of thermal expansion. On the contrary, it has been noted that where the expendable part 100 comprises purely polymeric sacrificial materials, during debinding, the polymers fully melt into a liquid that gives rise to considerable volume expansion and possibly substantial out-gassing of the sacrifical polymeric material. Consequently, the expanded liquid within the debound green part can cause formation of cracks and extensive pin-holes in the debound green part as the melted polymer seeks room for expansion. Although this can be overcome by designing special flow channels in the green part, such a requirement introduces unnecessary constraints and limitations on the green part that can be formed, and is a significant drawback compared to when the expendable part comprises at least 10% of the second material.

Arising from the tight tolerances achievable in the object 400 when formed using the present method 10, there is no longer a need for second processes such as coining, machining, deburring, etc., to achieve the desired tight tolerances. It is further found that embodiments of the present method advantageously enable forming of relatively large objects with very tight tolerances, which was previously not achievable with conventional powder injection molding to the extent that conventional powder injection molding is generally suited only for making relatively small objects, such as rare earth magnet pole pieces for hard disk drives and stainless steel gear wheels for electric tooth brushes, that typically weigh from only 0.1 g to 250 g with cross sections typically less than 0.25 in. (6.35 mm). This is due to the fact that relatively large parts have increased fragility after debinding as they comprise a larger mass of unbound powder material. This makes them difficult to handle and prone to disintegration immediately prior to and during the sintering stage.

Including the at least one expendable part 100 in the present method 10 to provide integral support to the green part 200 after debinding and during sintering thereby allows relatively large objects to be formed while enjoying the advantages of powder injection molding of quick and low-cost forming and excellent dimensional tolerances. A non-exhaustive list of objects that may be considered “relatively large” in the context of the present powder injection molding technique includes gears, carburetor parts, turbine parts, etc. The method 10 is therefore particularly suitable for forming green parts 200 from ceramics and/or metallic materials.

Whilst there has been described in the foregoing description exemplary embodiments of the present invention, it will be understood by those skilled in the technology concerned that many variations in details of design, construction and/or, operation may be made without departing from the present invention.

1. A method of forming an object by powder injection molding, the object being formed from an injection molded integral body comprising a green part contiguous with an expendable part, the method comprising:
debinding the integral body to obtain a debound green part contiguous with a debound expendable part;
sintering the debound green part at a sintering temperature, the debound expendable part configured to at least partially define the debound green part and has a melting point higher than the sintering temperature; and
separating the debound expendable part from the sintered debound green part to form the object.

2. The method of claim 1, wherein during sintering of the debound green part, the debound expendable part remains substantially unsintered.

3. The method of claim 1, wherein during sintering of the debound green part, the debound expendable part remains chemically unreacted with the debound green part.

4. The method of claim 1, wherein sintering the debound green part comprises subjecting the debound integral body to the sintering temperature, the sintering temperature being lower than a temperature above which the debound green part ceases to sustain its pre-sintering shape.

5. The method of claim 1, further comprising injection molding a first feedstock in a mold cavity to form the green part contiguous with the expendable part, thereby forming the integral body, the mold cavity being defined by a first mold and the expendable part placed in the first mold prior to injection molding of the first feedstock.

6. The method of claim 5, wherein injection molding the first feedstock is performed at a temperature ranging from about 40° C. to about 100° C. at the first mold, and about 100° C. to about 200° C. at an injection nozzle.

7. The method of claim 5, wherein injection molding the first feedstock is performed at an injection pressure ranging from about 50 bar to about 3000 bar when flowing the first feedstock into the mold cavity, and a holding pressure ranging from about 200 bar to about 1000 bar when the mold cavity is substantially filled.

8. The method of claim 5, further comprising preparing the first feedstock by mixing a first material in powder form with a first binder at a temperature ranging from about 130° C. to about 200° C.

9. The method of claim 1, further comprising injection molding a second feedstock in a second mold to form the expendable part.

10. The method of claim 9, wherein injection molding the second feedstock is performed at a temperature ranging from about 40° C. to about 100° C. at the second mold, and about 130° C. to about 200° C. at an injection nozzle.

11. The method of claim 9, wherein injection molding the second feedstock is performed at an injection pressure ranging from about 50 bar to about 3000 bar when flowing the second feedstock into the second mold, and a holding pressure ranging from about 200 bar to about 1000 bar when the second mold is substantially filled.

12. The method of claim 9, further comprising preparing the second feedstock by mixing a second material in powder form with a second binder at a temperature ranging from about 130° C. to about 200° C.

13. The method of claim 9, wherein the second binder is compositionally the same as a first binder, the first binder being mixed with a first material to form a first feedstock used to form the green part.

14. The method of claim 12, wherein the second material constitutes a selectable volume ranging from about 10% to about 80% of the second feedstock.

15. The method of claim 12, wherein the second material is selected such that after sintering the debound green part, the second material remains essentially in powder form.

16. The method of claim 12, wherein the second material is selected to have a coefficient of thermal expansion smaller than or similar to a coefficient of thermal expansion of the debound green part.

17. The method of claim 1, wherein debinding the integral body comprises dissolving in at least one solvent at least one component of a first binder in the green part and at least one component of a second binder in the expendable part.

18. The method of claim 17, wherein the dissolving is performed at a temperature ranging from about 30° C. to about 80° C. for a time ranging from 8 to 24 hours.

19. The method of claim 1, wherein debinding the integral body comprises thermal debinding a first binder in the green part and a second binder in the expendable part from the green part and the expendable part respectively.

20. The method of claim 19, wherein the thermal debinding is performed by increasing the temperature of the integral body at a rate ranging from about 0.1 to about 1° C. per minute until a thermal debinding temperature ranging from about 500° C. to about 800° C. is attained, and maintaining the thermal debinding temperature for a time ranging from 2 to 6 hours.

21. The method of claim 1, wherein separating comprises mechanically removing the debound expendable part from the sintered debound green part.

22. A method of forming an object by powder injection molding, the method comprising:
placing an expendable body in a first mold to define a mold cavity;
injection molding a first feedstock in the mold cavity to form an integral body comprising a green part contiguous with the expendable body;
ejecting the integral body from the first mold;
debinding the integral body to obtain a debound green part contiguous with a debound expendable part;
sintering the debound green part at a sintering temperature, the debound expendable part configured to at least partially define the debound green part and has a melting point higher than the sintering temperature; and
separating the debound expendable part from the sintered debound green part to form the object.

23. A powder injection molded object formed by a method of forming the object by powder injection molding, the object being formed from an injection molded integral body comprising a green part contiguous with an expendable part, the method comprising:
debinding the integral body to obtain a debound green part contiguous with a debound expendable part;
sintering the debound green part at a sintering temperature, the debound expendable part configured to at least partially define the debound green part and has a melting point higher than the sintering temperature; and
separating the debound expendable part from the sintered debound green part to form the object.
